(19) United States
(12) Patent Application Publication
(10) Pub. No.: US 2026/0162860 A1
(43) Pub. Date: Jun. 11, 2026

(54) NdFeB RARE EARTH MAGNET AND A PREPARATION METHOD THEREOF

(71) Applicant: YANTAI DONGXING MAGNETIC MATERIALS INC., Yantai (CN)

(72) Inventors: Wang CHUANSHEN, Yantai (CN); Peng ZHONGJIE, Yantai (CN); Sun YONGCONG, Yantai (CN); Xu MINGFENG, Yantai (CN); Jia DAONING, Yantai (CN); Zhang BIN, Yantai (CN); Xia YUANGANG, Yantai (CN); Yang WEIDE, Yantai (CN); Ding KAIHONG, Yantai (CN)

(21) Appl. No.: 19/412,681

(22) Filed: Dec. 8, 2025

(30) Foreign Application Priority Data
Dec. 9, 2024 (CN) 202411796287.3

(51) Int. Cl. H01F 1/057

(52) U.S. Cl. CPC H01F 1/0577

(57) ABSTRACT

A sintered NdFeB permanent magnet comprises: a main phase, a two-particle grain boundary phase, and a triangular grain boundary phase. The main phase contains R₂T₁₄B, where R includes Nd and/or Pr, and T is Fe among Fe and Co. The two-particle grain boundary phase comprises: a copper-rich grain boundary phase, acicular ZrBₓ phase and/or acicular TiBₓ phase with a width of 10-50 nm. Within 20 nm from the interface of the main phase, the copper-rich grain boundary phase satisfies: 1.5<Cu/R≤2; within 50 nm from the center of the grain boundary, the copper-rich grain boundary phase satisfies: 1<Cu/R≤1.5. The triangular grain boundary phase comprises: FCC-type NdOₓ phase, RCu phase (where 1<Cu/R≤1.5), RGa phase (where 0.1<Ga/R≤0.5), R-rich phase, 6:14 phase, an acicular ZrBₓ phase and/or acicular TiBₓ phase with a width of 10-50 nm.

### CROSS REFERENCE TO RELATED APPLICATIONS

This U.S. utility patent application claims priority to and the benefit of China (CN) application No. 202411796287.3, filed Dec. 9, 2024, the content of which is incorporated herein by reference in its entirety.

### BACKGROUND OF THE INVENTION

### 1. Field of the Invention

The present invention relates to the technical field of NdFeB magnets, and more particularly to a NdFeB rare earth magnet and a preparation method thereof.

### 2. Description of the Prior Art

In recent years, NdFeB rare earth magnets have achieved rapid development and are widely used in high-tech fields such as new energy vehicles, air-conditioning compressors, and robots. Due to their high cost, cost reduction has become a crucial issue; therefore, NdFeB rare earth magnets that contain no heavy rare earths and have high performance have become the primary demand of current customers.

Heavy rare earth grain boundary diffusion is the most effective method to improve the performance of NdFeB rare earth magnets. However, heavy rare earths have low abundance and high prices, so the cost of heavy rare earth grain boundary diffusion remains very high. With the sharp increase in demand for high-performance NdFeB rare earth magnets and the soaring price of heavy rare earths, avoiding the use of heavy rare earths to reduce costs has become a key problem. The main component of the cost of NdFeB rare earth magnets is the proportion of heavy rare earths. Therefore, researchers, especially those in enterprises, have focused their research on manufacturing NdFeB rare earth magnets with low or no heavy rare earth content. Consequently, designing NdFeB rare earth magnets that contain no heavy rare earths and have high performance has become a research hotspot.

Chinese Invention Patent with Authorization Publication No. CN110299237B discloses an R-T-B series sintered magnet, which includes a plurality of main phase grains with R₂T₁₄B crystals, and a plurality of grain boundary junctions (as grain boundary phases surrounded by at least three of the main phase grains). The plurality of grain boundary junctions are classified into at least two phases: a transition metal-rich phase and an R-rich phase, and the R-rich phase is classified into at least two phases: a Cu-poor phase and a Cu-rich phase. This type of magnet exhibits excellent performance when it contains no heavy rare earths or only a trace amount of heavy rare earths.

Chinese Invention Patent with Authorization Publication No. CN111724959B discloses an R-T-B series permanent magnet. The R-T-B series permanent magnet contains Ga, where R is one or more rare earth elements, T is Fe or Fe and Co, and B is boron. It includes main phase grains composed of crystalline grains with an R₂T₁₄B-type crystal structure, and grain boundaries formed by two or more adjacent main phase grains, wherein the grain boundaries contain an R₆T₁₃Ga phase. This type of magnet exhibits excellent performance when it contains no rare earths. The present application proposes a high-performance heavy rare earth-free magnet with a novel structure, which is different from the above two disclosed solutions, and a preparation method thereof.

### SUMMARY OF THE INVENTION

Technical Objective: To overcome the deficiencies in the prior art, the present invention provides a NdFeB (NdFeB) rare earth magnet.

Technical Solution: To achieve the above objective, the present invention discloses a NdFeB rare earth magnet, which is a sintered NdFeB permanent magnet comprising a main phase, a two-particle grain boundary phase, and a triangular grain boundary phase. The main phase contains an R₂T₁₄B phase (in atomic percentage), where R refers to at least one of Nd (neodymium) and Pr (praseodymium), and T refers to at least Fe (iron) among Fe and Co (cobalt). The two-particle grain boundary phase comprises: a copper-rich grain boundary phase: within 20 nm from the interface of the main phase, the content of the copper-rich grain boundary phase satisfies 1.5<Cu/R≤2; within 50 nm from the center of the grain boundary, the content of the copper-rich grain boundary phase satisfies 1<Cu/R≤1.5; and/or an acicular ZrBₓ phase with a width of 10-50 nm; and/or an acicular TiBₓ phase with a width of 10-50 nm. The triangular grain boundary phase comprises: an FCC-type NdOₓ phase, an RCu phase (where 1<Cu/R≤1.5), an RGa phase (where 0.1<Ga/R≤0.5), an R-rich phase, a 6:14 phase, and/or an acicular ZrBₓ phase with a width of 10-50 nm, and/or an acicular TiBₓ phase with a width of 10-50 nm.

Further, based on 100% by mass percentage, the magnet comprises the following components: R: 29.5-33.5%; B: 0.85-1.05%; Al: 0.05-0.8%; Cu: 0.4-2.0%; Ga: 0.3-0.6%; Co: 0.5-2.0%; Zr or Ti: 0.15-0.5%; the remainder is Fe (iron) and unavoidable impurities.

Further, R may further contain at least one of La (lanthanum), Ce (cerium), Sm (samarium), Y (yttrium), Gd (gadolinium), Dy (dysprosium), Tb (terbium), and Ho (holmium).

The present application also provides a method for preparing the above NdFeB rare earth magnet, comprising the following steps:
S1: Subjecting raw materials to hydrogen absorption and dehydrogenation treatments to obtain hydrogen-treated ribbons of the main-phase alloy and ribbons of the relevant phases respectively;
S2: Mixing the ribbon of the main-phase alloy and the ribbons of the relevant phases obtained in Step S1 at a certain ratio, performing mechanical crushing to achieve solid solution between the amorphous alloy and the main alloy, crushing the mixed powder material into powder, and conducting magnetic field forming to obtain a green compact;
S3: Placing the green compact into a sintering furnace for sintering forming and heat preservation to obtain a sintered blank, and performing two-stage aging treatment to obtain the NdFeB rare earth magnet.

Further, in Step S1, the hydrogen absorption temperature is 50-100° C., the dehydrogenation temperature is 500-650° C., and the dehydrogenation time is 3-7 hours.

Further, in Step S2, the particle size after mechanical crushing is 10-25 μm, the D50 particle size of the powder obtained by crushing and pulverizing is 2-7 μm, and the density of the green compact is 4.0-4.5 g/cm³.

Further, in Step S3, the sintering temperature is 950-1100° C. with a heat preservation time of 4-15 hours; the first-stage aging temperature is 700-900° C. with a heat preservation time of 3-7 hours; the second-stage aging temperature is 430-550° C. with a heat preservation time of 3-7 hours.

### Advantageous Effects of the Present Invention

1. The NdFeB rare earth magnet prepared by this method contains no heavy rare earths, and has good uniformity and squareness (both above 0.97).

2. The coercivity and remanence of the NdFeB rare earth magnet can both be adjusted through the design of the grain boundary phase.

3. The grain boundary phase contains a relatively thick non-magnetic phase, which plays an excellent role in magnetic isolation and improves the coercivity of the magnet.

4. The grain boundary phase contains uniformly distributed acicular ZrBₓ phases or TiBₓ phases, providing excellent high-temperature resistance.

### BRIEF DESCRIPTION OF THE FIGURES

FIG. 1 is a schematic cross-sectional view of the NdFeB rare earth magnet according to the present invention;

FIG. 2 is a schematic diagram of the microstructure of the NdFeB rare earth magnet according to the present invention, where Label 1 denotes main phase grain (1); Label 2 denotes main phase grain (2); Label 3 denotes triangular grain boundary phase (3); Label 4 denotes two-particle grain boundary phase; Label 5 denotes acicular ZrBₓ phases and acicular TiBₓ phases;

FIG. 3 is a scanning electron microscope (SEM) image of the NdFeB rare earth magnet according to the present invention, where Label 1 denotes main phase; Label 2 denotes HCP-type Nd-rich phase; Label 3 denotes RCu phase; Label 4 denotes RGa phase; Label 5 denotes R-rich phase; Label 6 denotes 6:14 phase; Label 7 denotes acicular ZrBₓ phases and acicular TiBₓ phases;

FIG. 4 is an X-ray diffraction pattern of the FCC structure of the NdOₓ phase in Example 1 of the present invention;

FIG. 5 is an X-ray diffraction pattern of the 6:14 phase structure in Example 1 of the present invention;

FIG. 6 is an X-ray diffraction pattern of the R-rich phase structure in Example 1 of the present invention;

FIG. 7 is a schematic diagram of the two-particle grain boundary phase and its position in Example 1 of the present invention.

### DETAILED DESCRIPTION OF THE INVENTION

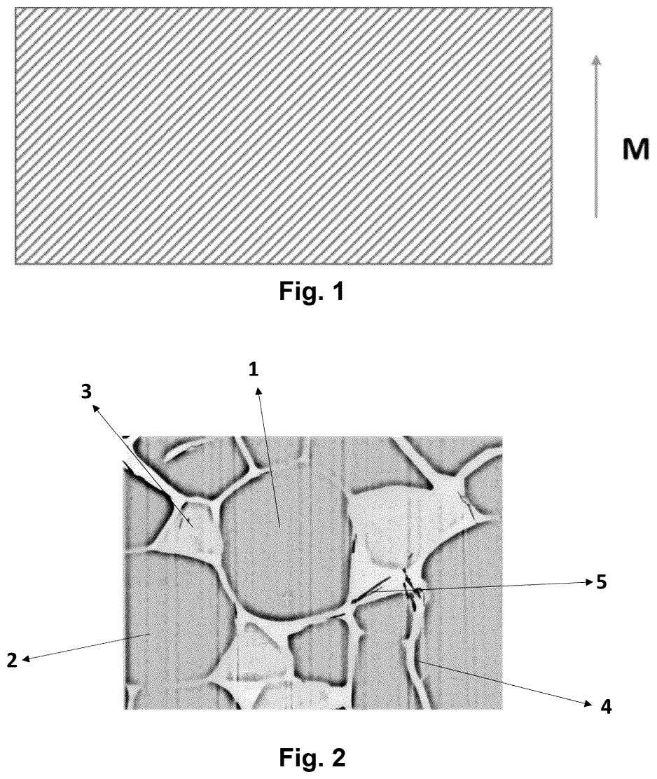

The principles and features of the present invention will be described below with reference to FIGS. 1 to 7. The examples provided are only for explaining the present invention and are not intended to limit the scope of the present invention.

A NdFeB rare earth magnet is a sintered NdFeB permanent magnet, comprising a main phase, a two-particle grain boundary phase, and a triangular grain boundary phase;

The main phase contains an R₂T₁₄B phase (in atomic percentage), where R refers to rare earth elements including at least one of Nd and Pr, and T refers to Fe, or Fe and Co. The R₂T₁₄B phase consists of single main phase grains, with an average particle size of 2 μm-7 μm. In addition to at least one of Nd and Pr, R may further contain at least one of La, Ce, Sm, Y, Gd, Dy, Tb, and Ho.

The two-particle grain boundary phase comprises:
A copper-rich grain boundary phase: within 20 nm from the interface of the main phase, the content of the copper-rich grain boundary phase satisfies 1.5<Cu/RZ≤2; within 50 nm from the center of the grain boundary, the content of the copper-rich grain boundary phase satisfies 1<Cu/R≤1.5;
and/or an acicular ZrBₓ phase with a width of 10-50 nm;
and/or an acicular TiBₓ phase with a width of 10-50 nm;

The triangular grain boundary phase comprises: an FCC-type NdOₓ phase, an RCu phase (where 1<Cu/R≤1.5), an RGa phase (where 0.1<Ga/R≤0.5), an R-rich phase, a 6:14 phase, and/or an acicular ZrBₓ phase with a width of 10-50 nm, and/or an acicular TiBₓ phase with a width of 10-50 nm.

Specifically, the acicular ZrBₓ phase or TiBₓ phase refers to a ZrB phase or a ZrB₂ phase.

The main phase, two-particle grain boundary phase, and triangular grain boundary phase are present in cross-sections perpendicular or parallel to the C-axis, and the phases in the triangular grain boundary phase may also be present in the two-particle grain boundary phase.

Specifically, as shown in FIG. 1, samples are prepared by observing any part of the interface for testing. The testing methods include microstructure observation via scanning electron microscope (SEM) and observation of grain boundary microstructure and microelement distribution via transmission electron microscope (TEM). The cross-section in the figure is rectangular, but its actual shape is not limited to rectangular; it may also be square, tile-shaped, steamed bun-shaped, cylindrical, arc-shaped, etc.

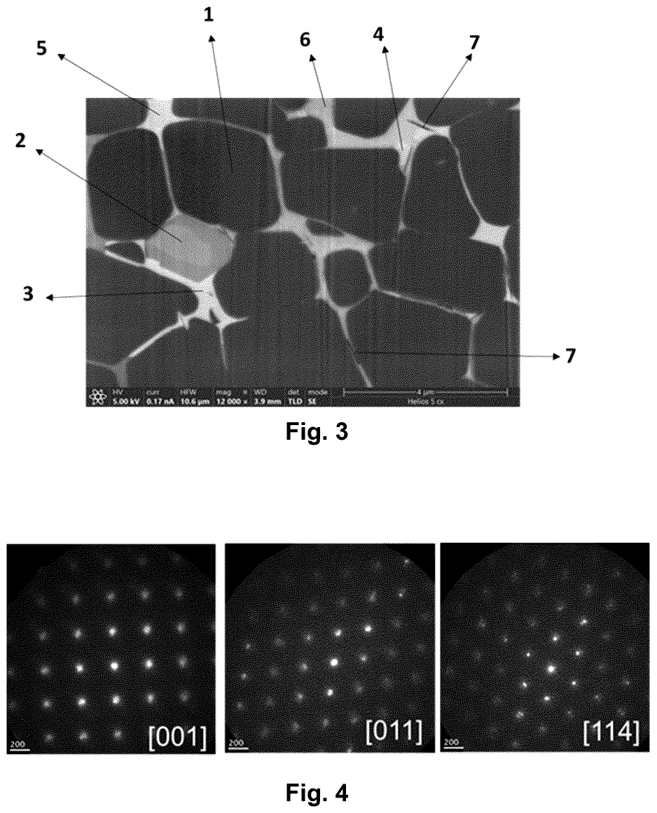

As shown in FIG. 2, the NdFeB rare earth magnet includes main phase grain (1) and main phase grain (2). Main phase grain (1) and main phase grain (2) may have the same composition, or may further have different compositions (e.g., dual main phases, triple main phases). The main phase may further contain Tb₂ Fe₁₄B, Dy₂Fe₁₄B, Ho₂Fe₁₄B, Gd₂Fe₁₄B, Y₂Fe₁₄B, La₂ Fe₁₄B, Ce₂Fe₁₄B, etc. In addition to the above elements, the main phase grains may also contain elements such as Al, Ga, and Cu. Meanwhile, main phase grain (1) and main phase grain (2) may have a certain concentration gradient, such as a concentration gradient of heavy rare earths (Tb, Dy, Ho) or elements (Cu, Al, Ga). The main phase corresponds to Label 1 in FIG. 3.

The triangular grain boundary phase (3) in FIG. 2 refers to phases other than the main phase and the two-particle grain boundary phase. The triangular grain boundary phase (3) contains an FCC phase of NdOₓ, i.e., neodymium oxide with a certain proportion of FCC phase. The misfit between the main phase and FCC-NdOₓ along [011] and (111) is only 4.2%, which increases the magnetic isolation ratio at the grain boundaries of the NdFeB rare earth magnet, thereby improving the magnet's coercivity. The oxygen content of this phase is generally 10 at %-45 at %. Meanwhile, the neodymium-iron triangular grain boundary phase may further contain a DHCP-type Nd-rich phase and an HCP-type Nd-rich phase. The DHCP-type Nd-rich phase is more likely to exist in the two-particle grain boundary phase or the triangular grain boundary phase, while the HCP-type Nd-rich phase is mostly formed due to improper oxygen content control or increased oxygen content caused by prolonged storage. The content of the HCP-type Nd-rich phase is very low (accounting for less than 15% of the triangular grain boundary phase), and this phase corresponds to Label 2 in FIG. 3.

The triangular grain boundary phase (3) contains an RCu phase, which may be a PrCu phase, an NdCu phase, or an NdPrCu phase, etc. The atomic ratio of the RCu phase satisfies 1<Cu/R≤1.5, where R refers to the sum of the atomic amounts of Nd and Pr. Meanwhile, the neodymium-iron triangular grain boundary phase may further contain phases such as LaCu, CeCu, GdCu, DyCu, TbCu, and HoCu, with their atomic ratios also satisfying 1<Cu/R≤1.5. The RCu phase accounts for 15%-50% of the triangular grain boundary phase and corresponds to Label 3 in FIG. 3.

The triangular grain boundary phase (3) in FIG. 2 contains an RGa phase, which may be a PrGa phase, an NdGa phase, or an NdPrGa phase, etc. The atomic ratio of the RGa phase satisfies 0.1<Ga/R≤0.5, where R refers to the sum of the atomic amounts of Nd and Pr. Meanwhile, the triangular grain boundary phase may further contain phases such as LaGa, CeGa, GdGa, DyGa, TbGa, and HoGa, with their atomic ratios also satisfying 0.1<Ga/R≤0.5. Additionally, the RGa phase may further include composite phases containing elements such as Co, Al, Cu, Fe, Mg, Zn, Mo, Ti, Zr, Sb, and Bi. The RGa phase accounts for 10% or less of the triangular grain boundary phase and corresponds to Label 4 in FIG. 3.

The triangular grain boundary phase (3) in FIG. 2 contains an R-rich phase, which is mainly dominated by the proportion of R (where R refers to the sum of the atomic amounts of Nd and Pr). Further, the R element in the triangular grain boundary phase may also include rare earth elements such as La, Ce, Sm, Y, Gd, Dy, Tb, and Ho. Meanwhile, R may contain a certain amount of Fe (with a content range of 0-20 at %). Further, R may also contain elements such as Co, Al, Cu, Fe, Mg, Zn, Mo, Ti, Zr, Sb, and Bi, but the content of these elements is not fixed and may be zero in some cases. The R-rich phase may sometimes exist in an amorphous form, and the R-rich phase accounts for 35% or less of the triangular grain boundary phase. The R-rich phase corresponds to Label 5 in FIG. 3.

The triangular grain boundary phase (3) in FIG. 2 contains a 6:14 phase, which satisfies the proportional relationship of the 6:14 phase and mainly exists as an R₆ T₁₃ (GaCu) 1 phase. The 6:14 phase may further contain at least one of Al, Mg, Zn, Ti, Zr, Mo, Sb, and Bi. In addition, T refers to at least one of Fe and Co; R mainly refers to Pr and Nd, and may further include rare earth elements such as La, Ce, Sm, Y, Gd, Dy, Tb, and Ho. The 6:14 phase contains at least 4 types of elements and accounts for 20%-50% of the triangular grain boundary phase. The 6:14 phase corresponds to Label 6 in FIG. 3.

The triangular grain boundary phase (3) in FIG. 2 contains an acicular ZrBₓ phase (with a width of 10-50 nm) and/or an acicular TiBₓ phase (with a width of 10-50 nm). The acicular ZrBₓ phase and acicular TiBₓ phase are mainly high-melting-point phases, specifically referring to ZrB₂ or TiB₂ phases; the high-melting-point phases may also contain high-melting-point elements such as Mo and W. Further, the high-melting-point phases may have shapes such as dots or lines. Due to the presence of these high-melting-point phases, magnetic domain pinning is achieved, thereby endowing the magnet with high coercivity and high-temperature resistance. The acicular ZrBₓ phases and acicular TiBₓ phases are mainly distributed in the triangular grain boundary phase or the two-particle grain boundary phase, with distribution positions along the grain boundaries or at the edges or centers of the triangular regions. These high-melting-point phases may be distributed in the R-rich phase, 6:14 phase, RCu phase, RGa phase, or adjacent to neodymium oxide. The acicular ZrBₓ phases and acicular TiBₓ phases are dispersedly distributed and not fixed in specific phases. The distribution positions of the acicular ZrBₓ phases and acicular TiBₓ phases are shown in Label 5 (in the form of black acicular shapes) in FIG. 2, corresponding to Label 7 in FIG. 3.

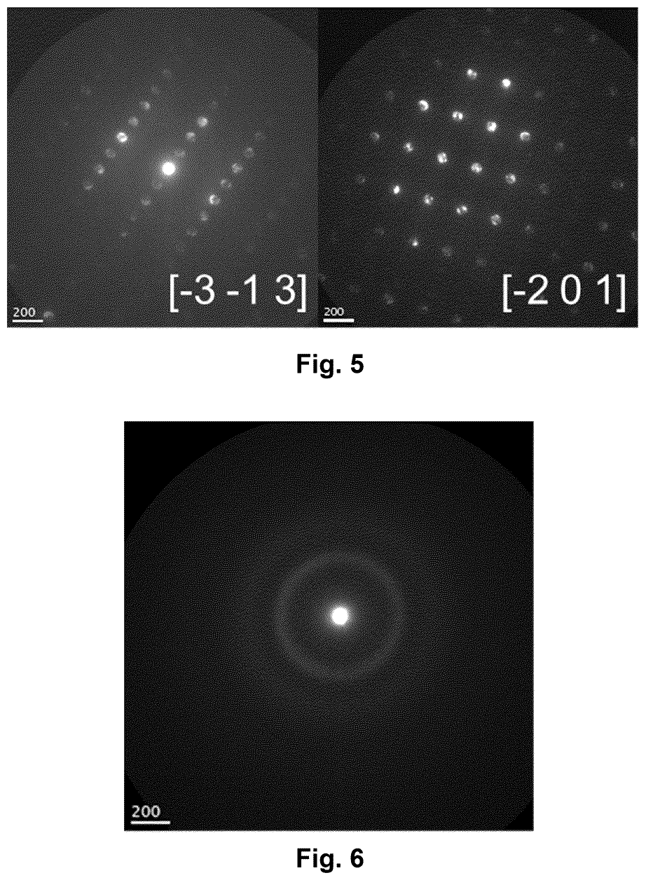

The triangular grain boundary phase (3) comprises the FCC phase of NdOₓ, RCu phase, RGa phase, 6:14 phase, and/or acicular ZrBₓ phase or TiBₓ phase. These phases do not necessarily exist independently; they may coexist in an overlapping manner within a single triangular region. Two-phase coexistence may occur, such as the coexistence of RCu phase and FCC phase of NdOₓ, RGa phase and FCC phase of NdOₓ, Nd-rich phase and FCC phase of NdOₓ, Nd-rich phase and 6:14 phase, 6:14 phase and acicular ZrBₓ phase, or 6:14 phase and acicular TiBₓ phase. Three-phase coexistence may also occur, for example, the coexistence of Nd-rich phase, 6:14 phase, and acicular ZrBₓ phase or acicular TiBₓ phase. Additionally, a single phase may exist independently in a triangular region, such as the FCC phase of NdOₓ or the 6:14 phase. Through transmission electron microscope (TEM) testing, FIG. 4 (the diffraction pattern of the FCC structure of the NdOₓ phase in Example 1) verifies the existence of the FCC phase of NdOₓ; FIG. 5 (the diffraction pattern of the 6:14 phase structure in Example 1) verifies the existence of the 6:14 phase; and FIG. 6 (the diffraction pattern of the R-rich phase structure in Example 1) verifies the existence of the R-rich phase.

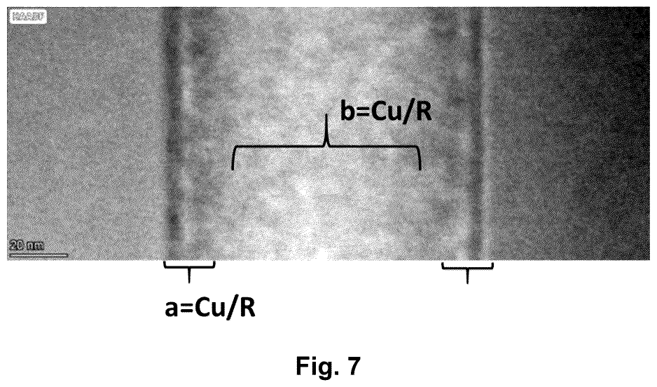

FIG. 7 is a schematic diagram of the two-particle grain boundary and its position in Example 1 (captured by a transmission electron microscope). At position “a” in the figure, the copper-rich grain boundary phase is within 20 nm from the main phase interface, satisfying 1.5<Cu/R≤2 (where a=20 nm). At position “b” in the figure, the copper-rich grain boundary phase is within 50 nm of the grain boundary centerline, satisfying 1<Cu/R≤1.5 (where b=50 nm). The two-particle grain boundary refers to the boundary between two main phase grains, with a width ranging from 2 nm to 500 nm and an average width of generally 100 nm. The composition distribution of the grain boundary follows an obvious rule: the Cu content at the edge is significantly higher than that at other positions of the grain boundary, and where the Cu content increases, the contents of Pr and Nd decrease significantly. This rule typically applies within 20 nm from the main phase interface, but it may also apply at positions farther from the main phase interface (e.g., 30 nm from the interface). The contents of Cu, Nd, and Pr are significantly higher than those of other elements in the grain boundary. Furthermore, other R elements may follow a similar rule. R mainly refers to Pr and Nd, and may also contain rare earth elements such as La, Ce, Sm, Y, Gd, Dy, Tb, and Ho. Additionally, elements such as Al, Cu, Mg, and Zn may follow a similar rule to Cu-their contents at the edge are significantly higher than those at other positions of the grain boundary, while the contents of elements such as Pr and Nd at these edge positions decrease significantly (typically within the range of “a” from the main phase interface). This rule may also apply at positions farther from the main phase interface (e.g., within the range of “a” from the interface). The copper-rich grain boundary phase within the grain boundary centerline “b” satisfies 1<Cu/R≤1.5. Similarly, at positions where the centerline is longer, the contents of Cu and rare earth elements (Pr, Nd) are significantly higher than those of other elements, and the Cu content is higher than the R content, satisfying 1<Cu/R≤1.5. R mainly refers to Pr and Nd, and may also contain rare earth elements such as La, Ce, Sm, Y, Gd, Dy, Tb, and Ho. Furthermore, elements such as Al, Cu, Mg, and Zn may follow a similar rule to Cu.

The acicular ZrBₓ phase has a width of 10-50 nm, and the acicular TiBₓ phase also has a width of 10-50 nm (where R refers to at least one of Nd and Pr, in atomic percentage). When distributed in the two-particle grain boundary phase, these phases may exist as high-melting-point phases along the grain boundary or as acicular structures perpendicular to the grain boundary. Zr and Ti are high-melting-point elements, so the high-melting-point phases may also contain other high-melting-point elements such as Mo and W. Furthermore, the high-melting-point phases may have shapes such as dots or lines. The presence of these high-melting-point phases plays a role in pinning magnetic domains, endowing the magnet with high coercivity and high-temperature resistance. This phase corresponds to Label 7 in FIG. 3, which marks the position of the two-particle grain boundary phase.

The NdFeB rare earth magnet exhibits high performance, including high coercivity, high remanence, and high squareness.

Therefore, the magnet satisfies any of the following conditions: [0058] Within 20 nm from the main phase interface, the two-particle grain boundary phase satisfies 1.5<Cu/(Nd+Pr)≤1.6, 1.5<Cu/(Nd+Pr)≤1.7, 1.5<Cu/(Nd+Pr)≤1.8, 1.5<Cu/(Nd+Pr)≤1.9, 1.5<Cu/(Nd+Pr)≤2.0, 1.6≤Cu/(Nd+Pr)≤1.7, 1.6≤Cu/(Nd+Pr)≤1.8, 1.6≤Cu/(Nd+Pr)≤1.9, 1.6≤Cu/(Nd+Pr)≤2.0, 1.7≤Cu/(Nd+Pr)≤1.8, 1.7≤Cu/(Nd+Pr)≤1.9, or 1.7≤Cu/(Nd+Pr)≤2.0;

At the center of the two-particle grain boundary phase, the copper-rich grain boundary phase is within 100 nm of the grain boundary center, and the RCu phase in the triangular region satisfies 1<Cu/R≤1.2, 1<Cu/R≤1.3, 1<Cu/R≤1.4, 1<Cu/R≤1.5, 1.1<Cu/R≤1.2, 1.1<Cu/R≤1.3, 1.1<Cu/R≤1.4, 1.1<Cu/R≤1.5, 1.2<Cu/R≤1.3, 1.2<Cu/R≤1.4, 1.2<Cu/R≤1.5, 1.3<Cu/R≤1.4, 1.3<Cu/R≤1.5, or 1.4<Cu/R≤1.5; [0060] The RGa phase in the triangular region satisfies 0.1<Ga/R≤0.2, 0.1<Ga/R≤0.3, 0.1<Ga/R≤0.4, 0.1<Ga/R≤0.5, 0.2<Ga/R≤0.3, 0.2<Ga/R≤0.4, 0.2<Ga/R≤0.5, 0.3<Ga/R≤0.4, 0.3<Ga/R≤0.5, or 0.4<Ga/R≤0.5.

The remanence of the NdFeB rare earth magnet is mainly affected by factors such as the volume fraction of positive domains, the proportion of non-magnetic phases, relative density, and the orientation degree of magnetic domains. Therefore, when designing magnets with different remanence values, it is only necessary to compare these parameters. The coercivity of the NdFeB magnet is affected by the magnet's anisotropy field, structure factor, demagnetization factor, and saturation magnetic polarization, while the squareness is mainly affected by the magnet's uniformity. The mechanism underlying the high performance of the NdFeB rare earth magnet is analyzed as follows:

The triangular grain boundary phase includes the FCC phase of NdOₓ, RCu phase, RGa phase, 6:14 phase, and/or acicular ZrBₓ phase or TiBₓ phase; the two-particle grain boundary phase includes the copper-rich phase, Nd-rich phase, 6:14 phase, etc.

The triangular grain boundary phase contains the FCC phase of NdOₓ, which has a low misfit with the main phase. This can optimize the microstructure of the NdFeB rare earth magnet-reducing the misfit lowers the stray field and the proportion of defects, thereby improving the magnet's coercivity. The triangular grain boundary phase also contains the RCu phase and RGa phase (both non-magnetic phases), which can achieve magnetic isolation between two or more adjacent main phase grains, further improving the magnet's coercivity. The weakly magnetic 6:14 phase in the triangular grain boundary phase and the copper-rich phase in the two-particle grain boundary phase can form grain boundary phases with good continuity; meanwhile, the grain boundary phases of a certain thickness effectively achieve magnetic isolation between main phase grains, increasing the magnet's coercivity. The acicular ZrBₓ phase or TiBₓ phase in both the triangular grain boundary phase and the two-particle grain boundary phase can prevent magnetic deflection of grain magnetic domains and play a pinning role, thereby improving the magnet's coercivity. The proportional relationship between the triangular grain boundary phase, two-particle grain boundary phase, and main phase is a factor determining the remanence. Additionally, under the same magnetization intensity, the FCC phase of NdOₓ, RCu phase, RGa phase, 6:14 phase, and/or acicular ZrBₓ phase or TiBₓ phase in the triangular grain boundary phase, as well as the copper-rich phase in the two-particle grain boundary phase, can better increase the volume fraction of positive domains in the magnet, thereby improving the magnet's remanence. Furthermore, increasing the sintering temperature (without causing “bright spots” in the magnet) can increase the magnet's relative density, which in turn improves remanence-consistent with the principle of increasing magnet remanence.

The mechanism by which the NdFeB rare earth magnet increases coercivity is not limited to the above-described mechanism.

The R content of the NdFeB rare earth magnet is 29.5-33.5% (by mass percentage), with an optimal range of 30-32%. The rare earth element R mainly refers to at least one of Pr and Nd. For the magnet to exhibit excellent performance, a special microstructure (such as the structural features proposed in this scheme) must be designed. R is mainly involved in the formation of the main phase and grain boundary phases: it participates in forming the main phase (i.e., forming R₂T₁₄B, such as Nd₂Fe₁₄B and Pr₂Fe₁₄B) and also participates in forming grain boundary phases (including the triangular grain boundary phase and two-particle grain boundary phase). When the magnet's grain boundaries are constructed as continuous structures with corresponding grain boundary phase compositions, a higher R content results in better magnetic isolation in the microstructure, thereby significantly increasing the magnet's coercivity. The grain boundaries are designed based on the excess R ratio beyond that used in forming the main phase; a higher proportion of grain boundaries leads to a corresponding decrease in magnet remanence. By designing magnets with different compositions according to the required microstructure, NdFeB rare earth magnets with different performances can be obtained.

The B content of the NdFeB rare earth magnet is 0.85-1.05% (by mass percentage), with an optimal range of 0.85-0.95%. B is crucial for forming the tetragonal phase of Nd₂Fe₁₄B: it functions to increase the atomic spacing between Fe atoms and reduce the number of nearest neighbors of Fe atoms. Therefore, the addition of B significantly improves the magnetic properties of the magnet. As the B content increases from 0, the a-Fe and Nd₂Fe₁₇ phases in the magnet gradually disappear, while the tetragonal Nd₂ Fe₁₄B phase gradually forms. Thus, controlling the B content in the magnet allows control over the proportion and composition of the main phase and grain boundary phases, thereby regulating the magnet's remanence and coercivity. Additionally, adding other elements can further tailor the composition of the magnet's grain boundary phases: adding a certain amount of Cu enables the triangular grain boundary phase or two-particle grain boundary phase to contain a copper-rich phase. Since Cu is a non-magnetic element, a certain Cu content can help increase the magnet's coercivity. The grain boundary phases may contain ZrB phase or TiB phase (with a phase ratio of 1:1 or 1:2), as well as other B-containing alloy phases.

The Al content of the NdFeB rare earth magnet is 0.05-0.8% (by mass percentage), with an optimal range of 0.1-0.6%. The addition of Al can refine the grains of the main phase, reduce the size of Nd-rich and B-rich phases, and improve the wettability between the Nd-rich phase and the main phase. Al can enter the main phase to form Nd₂Fe₁₄₋ₓBAlₓ or enter the grain boundary phases to form Al-containing 6:14 phases. The Al-containing 6:14 phase may exist in the triangular region or the two-particle grain boundary phase. As an interstitial atom, Al can be present in various phases, including the 6:14 phase, copper-rich phase, and Nd-rich phase.

The Cu content of the NdFeB rare earth magnet is 0.4-2.0% (by mass percentage), which can also range from 1.5-2.0%, 0.4-1.0%, or 1.0-1.5%. Cu can reduce the irreversible loss of the magnet, distribute uniformly in the Nd-rich phase, improve the grain boundary phase, and enhance corrosion resistance and oxidation resistance. Cu can replace Fe atoms in the main phase near the grain boundary to form Nd₂Fe₁₄₋ₓBCuₓ or enter the grain boundary phases to form Cu-containing 6:14 phases. Cu can also form a copper-rich phase, which may exist in the triangular grain boundary phase or the two-particle grain boundary phase. In summary, as an interstitial atom, Cu can be present in various phases, including the 6:14 phase, copper-rich phase, and Nd-rich phase.

The Ga content of the NdFeB rare earth magnet is 0.3-0.6% (by mass percentage). Ga can lower the melting point of grain boundaries, distribute uniformly in the grain boundary phases, improve the structure of grain boundary phases, and repair defects in the magnet. Ga can replace Fe atoms in the main phase near the grain boundary to form Nd₂Fe₁₄₋ₓBGaₓ or enter the grain boundary phases to form Ga-containing 6:14 phases. Ga can also form a Ga-rich phase, which may exist in the triangular grain boundary phase or the two-particle grain boundary phase. In summary, as an interstitial atom, Ga can be present in various phases, including the 6:14 phase, copper-rich phase, and Nd-rich phase.

The Co content of the NdFeB rare earth magnet is 0.5-2.0% (by mass percentage). Cobalt primarily enhances the high-temperature stability of the magnet; it forms stable Nd₃Co at grain boundaries and can also improve the magnet's corrosion resistance. The Co content can alternatively range from 0.5-1.0%. Similarly, as an interstitial atom, Co can exist in various phases, including the 6:14 phase, copper-rich phase, Nd-rich phase, and main phase.

The Zr or Ti content of the NdFeB rare earth magnet is 0.15-0.5% (by mass percentage). As high-melting-point elements, Zr or Ti can refine grains and form high-melting-point borides or carbides. Similarly, as interstitial atoms, Zr or Ti can exist in various phases, including the 6:14 phase, copper-rich phase, and Nd-rich phase.

The impurity carbon (C) content of the NdFeB rare earth magnet is below 1200 ppm, with a preferred range of 300-800 ppm. Excessively high C content damages the main phase, impairs the continuity of grain boundary phases, and leads to reduced performance.

The impurity oxygen (O) content of the NdFeB rare earth magnet is below 900 ppm, with a preferred range of 200-700 ppm. Excessively high O content results in the formation of large amounts of HCP-type neodymium oxides. These HCP-type oxides exhibit significant lattice damage thickness and numerous defects, which increase the misfit between the oxide phase and the main phase, raise the stray field, and thereby cause a sharp decline in magnet performance.

The impurity nitrogen (N) content of the NdFeB rare earth magnet is below 1500 ppm, with a preferred range of 500-1000 ppm. Excessively high N content leads to the formation of rare earth nitrides, which in turn reduces magnet performance.

### Example 1

The method for preparing the aforementioned NdFeB rare earth magnet includes the following steps:

S1: Subject raw materials to hydrogen absorption and dehydrogenation treatments to obtain hydrogen-treated ribbons of the main-phase alloy and ribbons of relevant phases, respectively. The ribbons of relevant phases may be copper-gallium-rich phase ribbons, etc., and are rapidly quenched amorphous ribbons.

Specifically, for the NdFeB rare earth magnet, the raw materials for preparing the main-phase alloy ribbons and relevant phase ribbons are determined through composition design. The raw materials used can be pure metals, rare earth-containing alloys, non-rare earth-containing alloys, iron, ferroboron, etc. The hydrogen absorption treatment can be either low-temperature or high-temperature hydrogen absorption, while the dehydrogenation treatment can be either high-temperature dehydrogenation or low-temperature long-duration dehydrogenation.

Specifically, in this example, low-temperature hydrogen absorption is adopted, with a hydrogen absorption temperature of 50° C., a dehydrogenation temperature of 500° C., and a dehydrogenation duration of 7 hours. The relevant phase ribbons are rapidly quenched amorphous ribbons with an alloy composition of Pr₆₀Nd₁₀Cu₂₀Ga₁₀ (in atomic ratio).

S2: Mix the main-phase alloy ribbons and relevant phase ribbons obtained in Step S1 at a certain ratio, perform mechanical crushing to achieve solid solution between the amorphous alloy and the main alloy (thereby introducing copper-rich and gallium-rich phases into the grain boundaries), crush the mixed powder material into fine powder (the pulverization process can be ball milling or jet milling, and a small amount of oxygen may be introduced during pulverization), and conduct magnetic field forming to obtain a green compact. Magnetic field forming involves simultaneous compression molding and magnetic field orientation; after magnetic field forming, the green compact may undergo isostatic pressing followed by sintering and aging, or be directly subjected to sintering and aging.

Specifically, in this example, the weight ratio of the relevant phase ribbons is 2%, the particle size after mechanical crushing is 20 μm, jet milling is used for pulverization, the powder has a D50 particle size of 3.5 μm, and the green compact has a density of 4.5 g/cm³ after magnetic field forming.

S3: Place the green compact in a sintering furnace for sintering and heat preservation to obtain a sintered blank, then perform two-stage aging treatment to obtain the NdFeB rare earth magnet.

The sintering process primarily improves the magnet's remanence and strength by increasing density and optimizing the contact properties between powder particles, thereby endowing the magnet with a microstructure characteristic of high permanent magnetic performance. This process is dominated by liquid-phase sintering. During magnet sintering, high-melting-point plates (such as molybdenum plates or zirconium plates) can be used as backing plates, or a mixed gas (e.g., nitrogen, argon, hydrogen) can be introduced to prevent magnet oxidation.

The first stage of aging involves melting the Nd-rich phase to form a flowing liquid phase, which flows and penetrates into the gaps between powder particles, melts the sharp corners of grains to round them, and ensures further optimized distribution of the magnet's grain boundary phases. Additionally, during this process, alloy powders (such as PrNd, PrAl, PrAlCu, PrAlGa, etc.) can be added to the surface of the sintered blank.

The second stage of aging converts the grain boundary phases into a liquid phase that flows between grains and distributes uniformly and dispersedly in the grain boundaries, making the grain boundaries regular and smooth, increasing the difficulty of reverse magnetic domain nucleation, and reducing the demagnetizing field of the main phase grains. After heat treatment, the Nd-rich phase at the grain boundaries is fully and uniformly distributed, which better isolates the main phase grains, eliminates the magnetic exchange coupling between grains, and improves the magnet's coercivity (Hcj), maximum energy product ((BH)m), and squareness. This stage mainly forms copper-rich or gallium-rich phases and 6:14 phases, promoting the uniform and continuous distribution of low-melting-point phases in the grain boundaries. These copper-rich/gallium-rich phases and 6:14 phases better isolate the main phase, achieving demagnetization coupling and further enhancing the magnet's coercivity and squareness.

Specifically, in this example, the sintering temperature is 1070° C. with a heat preservation duration of 6 hours; the first-stage aging temperature is 880° C. with a duration of 3 hours; the second-stage aging temperature is 430° C. with a duration of 7 hours. The final NdFeB rare earth magnet has the following composition (by mass percentage): 29.5% PrNd, 0.05% Al, 0.94% B, 0.5% Co, 0.4% Cu, 0.3% Ga, 0.3% Zr, and the remainder is Fe and impurities. The impurity contents are 800 ppm C, 900 ppm N, and 700 ppm O. The remanence (Br), coercivity (Hcj), and squareness (Hk/Hcj) of the obtained NdFeB rare earth magnet, measured at room temperature (20° C.) using a NIM-2000 magnetic property tester, are detailed in Table 1; the atomic percentages of each element in the NdFeB rare earth magnet are detailed in Table 3.

### Example 2

This example differs from Example 1 above in the method for preparing the NdFeB rare earth magnet, which includes the following steps:

S1: Subject raw materials to hydrogen absorption and dehydrogenation treatments to obtain hydrogen-treated ribbons of the main-phase alloy and ribbons of relevant phases, respectively. The ribbons of relevant phases may be copper-gallium-rich phase ribbons, etc., and are rapidly quenched amorphous ribbons.

Specifically, for the NdFeB rare earth magnet, the raw materials for preparing the main-phase alloy ribbons and relevant phase ribbons are determined through composition design. The raw materials used can be pure metals, rare earth-containing alloys, non-rare earth-containing alloys, iron, ferroboron, etc. The hydrogen absorption treatment can be either low-temperature or high-temperature hydrogen absorption, while the dehydrogenation treatment can be either high-temperature dehydrogenation or low-temperature long-duration dehydrogenation.

Specifically, in this example, room-temperature hydrogen absorption is adopted, with a dehydrogenation temperature of 600° C., a dehydrogenation duration of 5 hours, and the relevant phase ribbons are rapidly quenched amorphous ribbons with an alloy composition of Pr₄₀Nd₁₀ Cu₄₀Ga₁₀ (in atomic ratio).

S2: Mix the main-phase alloy ribbons and relevant phase ribbons obtained in Step S1 at a certain ratio, perform mechanical crushing to achieve solid solution between the amorphous alloy and the main alloy (thereby introducing copper-rich and gallium-rich phases into the grain boundaries), crush the mixed powder material into fine powder (the pulverization process can be ball milling or jet milling, and a small amount of oxygen may be introduced during pulverization), and conduct magnetic field forming to obtain a green compact. Magnetic field forming involves simultaneous compression molding and magnetic field orientation; after magnetic field forming, the green compact may undergo isostatic pressing followed by sintering and aging, or be directly subjected to sintering and aging.

Specifically, in this example, the weight ratio of the relevant phase ribbons is 4%, the particle size after mechanical crushing is 15 μm, jet milling is used for pulverization, the powder has a D50 particle size of 3.5 μm, and the green compact has a density of 4.2 g/cm³ after magnetic field forming.

S3: Place the green compact in a sintering furnace for sintering and heat preservation to obtain a sintered blank, then perform two-stage aging treatment to obtain the NdFeB rare earth magnet.

Specifically, in this example, the sintering temperature is 1100° C. with a heat preservation duration of 4 hours; the first-stage aging temperature is 850° C. with a duration of 3 hours; the second-stage aging temperature is 450° C. with a duration of 3 hours. The final NdFeB rare earth magnet has the following composition (by mass percentage): 32% PrNd, 0.05% Al, 0.85% B, 2.0% Co, 2.0% Cu, 0.4% Ga, 0.5% Zr, and the remainder is Fe and impurities. The impurity contents are 700 ppm C, 600 ppm N, and 800 ppm O. The remanence (Br), coercivity (Hcj), and squareness (Hk/Hcj) of the obtained NdFeB rare earth magnet, measured at room temperature (20° C.) using a NIM-2000 magnetic property tester, are detailed in Table 1; the atomic percentages of each element in the NdFeB rare earth magnet are detailed in Table 3.

### Example 3

This example differs from Example 1 above in the method for preparing the NdFeB rare earth magnet, which includes the following steps:

S1: Subject raw materials to hydrogen absorption and dehydrogenation treatments to obtain hydrogen-treated ribbons of the main-phase alloy and ribbons of relevant phases, respectively. The ribbons of relevant phases may be copper-gallium-rich phase ribbons, etc., and are rapidly quenched amorphous ribbons.

Specifically, for the NdFeB rare earth magnet, the raw materials for preparing the main-phase alloy ribbons and relevant phase ribbons are determined through composition design. The raw materials used can be pure metals, rare earth-containing alloys, non-rare earth-containing alloys, iron, ferroboron, etc. The hydrogen absorption treatment can be either low-temperature or high-temperature hydrogen absorption, while the dehydrogenation treatment can be either high-temperature dehydrogenation or low-temperature long-duration dehydrogenation.

Specifically, in this example, low-temperature hydrogen absorption is adopted, with a hydrogen absorption temperature of 100° C., a dehydrogenation temperature of 550° C., and a dehydrogenation duration of 4 hours. The relevant phase ribbons are rapidly quenched amorphous ribbons with an alloy composition of Pr₅₀Nd₁₀Cu₂₀Ga₂₀ (in atomic ratio).

S2: Mix the main-phase alloy ribbons and relevant phase ribbons obtained in Step S1 at a certain ratio, and perform mechanical crushing to achieve solid solution between the amorphous alloy and the main alloy, thereby introducing copper-rich and gallium-rich phases into the grain boundaries. Crush the mixed powder material into fine powder; the pulverization process can be ball milling or jet milling, and a small amount of oxygen may be introduced during pulverization. Conduct magnetic field forming to obtain a green compact. Magnetic field forming refers to simultaneous compression molding and magnetic field orientation. After magnetic field forming, the green compact can undergo isostatic pressing followed by sintering and aging, or be directly subjected to sintering and aging.

Specifically, in this example, the weight ratio of the relevant phase ribbons is 3%, the particle size after mechanical crushing is 10 μm, jet milling is used for pulverization, the powder has a D50 particle size of 3.8 μm, and the green compact has a density of 4.0 g/cm³ after magnetic field forming.

S3: Place the green compact in a sintering furnace for sintering and heat preservation to obtain a sintered blank, then perform two-stage aging treatment to obtain the NdFeB rare earth magnet.

Specifically, in this example, the sintering temperature is 1050° C. with a heat preservation duration of 6 hours; the first-stage aging temperature is 750° C. with a duration of 5 hours; the second-stage aging temperature is 480° C. with a duration of 4 hours. The final NdFeB rare earth magnet has the following composition (by mass percentage): 30.8% PrNd, 0.07% Al, 0.90% B, 0.50% Co, 0.70% Cu, 0.60% Ga, 0.3% Zr, and the remainder is Fe and impurities. The impurity contents are 650 ppm C, 700 ppm N, and 700 ppm O. The data of remanence (Br), coercivity (Hcj), and squareness (Hk/Hcj) of the obtained NdFeB rare earth magnet, measured at room temperature (20° C.) using a NIM-2000 magnetic property tester, are detailed in Table 1; the atomic percentages of each element in the NdFeB rare earth magnet are detailed in Table 3.

### Example 4

The difference between this example and Example 1 above lies in the method for preparing the NdFeB rare earth magnet, which includes the following steps:

S1: Subject raw materials to hydrogen absorption and dehydrogenation treatments to obtain hydrogen-treated ribbons of the main-phase alloy and ribbons of relevant phases, respectively. The ribbons of relevant phases may be copper-gallium-rich phase ribbons, etc., and are rapidly quenched amorphous ribbons.

Specifically, for the NdFeB rare earth magnet, the raw materials for preparing the main-phase alloy ribbons and relevant phase ribbons are determined through composition design. The raw materials used can be pure metals, rare earth-containing alloys, non-rare earth-containing alloys, iron, ferroboron, etc. The hydrogen absorption treatment can be either low-temperature or high-temperature hydrogen absorption, while the dehydrogenation treatment can be either high-temperature dehydrogenation or low-temperature long-duration dehydrogenation.

Specifically, in this example, room-temperature hydrogen absorption is adopted, with a dehydrogenation temperature of 650° C., a dehydrogenation duration of 3 hours, and the relevant phase ribbons are rapidly quenched amorphous ribbons with an alloy composition of Pr₄₀Nd₁₀Cu₄₀Ga₁₀ (in atomic ratio).

S2: Mix the main-phase alloy ribbons and relevant phase ribbons obtained in Step S1 at a certain ratio, and perform mechanical crushing to achieve solid solution between the amorphous alloy and the main alloy, thereby introducing copper-rich and gallium-rich phases into the grain boundaries. Crush the mixed powder material into fine powder; the pulverization process can be ball milling or jet milling, and a small amount of oxygen may be introduced during pulverization. Conduct magnetic field forming to obtain a green compact. Magnetic field forming refers to simultaneous compression molding and magnetic field orientation. After magnetic field forming, the green compact can undergo isostatic pressing followed by sintering and aging, or be directly subjected to sintering and aging.

Specifically, in this example, the weight ratio of the relevant phase ribbons is 3.5%, the particle size after mechanical crushing is 25 μm, jet milling is used for pulverization, the powder has a D50 particle size of 4.0 μm, and the green compact has a density of 4.4 g/cm³ after magnetic field forming.

S3: Place the green compact in a sintering furnace for sintering and heat preservation to obtain a sintered blank, then perform two-stage aging treatment to obtain the NdFeB rare earth magnet.

Specifically, in this example, the sintering temperature is 1060° C. with a heat preservation duration of 8 hours; the first-stage aging temperature is 700° C. with a duration of 7 hours; the second-stage aging temperature is 500° C. with a duration of 3 hours. The final NdFeB rare earth magnet has the following composition (by mass percentage): 31.5% PrNd, 0.35% Al, 0.94% B, 0.8% Co, 1.2% Cu, 0.3% Ga, 0.15% Ti, and the remainder is Fe and impurities. The impurity contents are 750 ppm C, 500 ppm N, and 700 ppm O. The data of remanence (Br), coercivity (Hcj), and squareness (Hk/Hcj) of the obtained NdFeB rare earth magnet, measured at room temperature (20° C.) using a NIM-2000 magnetic property tester, are detailed in Table 1; the atomic percentages of each element in the NdFeB rare earth magnet are detailed in Table 3.

### Example 5

The difference between this example and Example 1 above lies in the method for preparing the NdFeB rare earth magnet, which includes the following steps:

S1: Subject raw materials to hydrogen absorption and dehydrogenation treatments to obtain hydrogen-treated ribbons of the main-phase alloy and ribbons of relevant phases, respectively. The ribbons of relevant phases may be copper-gallium-rich phase ribbons, etc., and are rapidly quenched amorphous ribbons.

Specifically, for the NdFeB rare earth magnet, the raw materials for preparing the main-phase alloy ribbons and relevant phase ribbons are determined through composition design. The raw materials used can be pure metals, rare earth-containing alloys, non-rare earth-containing alloys, iron, ferroboron, etc. The hydrogen absorption treatment can be either low-temperature or high-temperature hydrogen absorption, while the dehydrogenation treatment can be either high-temperature dehydrogenation or low-temperature long-duration dehydrogenation.

Specifically, in this example, room-temperature hydrogen absorption is adopted, with a dehydrogenation temperature of 500° C., a dehydrogenation duration of 7 hours, and the relevant phase ribbons are rapidly quenched amorphous ribbons with an alloy composition of Pr₅₀Nd₁₀Cu₄₀ (in atomic ratio).

S2: Mix the main-phase alloy ribbons and relevant phase ribbons obtained in Step S1 at a certain ratio, and perform mechanical crushing to achieve solid solution between the amorphous alloy and the main alloy, thereby introducing copper-rich phases into the grain boundaries. Crush the mixed powder material into fine powder; the pulverization process can be ball milling or jet milling, and a small amount of oxygen may be introduced during pulverization. Conduct magnetic field forming to obtain a green compact. Magnetic field forming refers to simultaneous compression molding and magnetic field orientation. After magnetic field forming, the green compact can undergo isostatic pressing followed by sintering and aging, or be directly subjected to sintering and aging.

Specifically, in this example, the weight ratio of the relevant phase ribbons is 2%, the particle size after mechanical crushing is 10 μm, jet milling is used for pulverization, the powder has a D50 particle size of 4.5 μm, and the green compact has a density of 4.1 g/cm³ after magnetic field forming.

S3: Place the green compact in a sintering furnace for sintering and heat preservation to obtain a sintered blank, then perform two-stage aging treatment to obtain the NdFeB rare earth magnet.

Specifically, in this example, the sintering temperature is 950° C. with a heat preservation duration of 15 hours; the first-stage aging temperature is 900° C. with a duration of 4 hours; the second-stage aging temperature is 550° C. with a duration of 3 hours. The final NdFeB rare earth magnet has the following composition (by mass percentage): 33.5% PrNd, 0.8% Al, 1.05% B, 1.5% Co, 0.8% Cu, 0.20% Ga, 0.10% Ti, and the remainder is Fe and impurities. The impurity contents are 500 ppm C, 400 ppm N, and 400 ppm O. The data of remanence (Br), coercivity (Hcj), and squareness (Hk/Hcj) of the obtained NdFeB rare earth magnet, measured at room temperature (20° C.) using a NIM-2000 magnetic property tester, are detailed in Table 1; the atomic percentages of each element in the NdFeB rare earth magnet are detailed in Table 3.

The only difference between Comparative Examples 1-5 and Examples 1-5 is the temperature of the second aging stage. The data of remanence (Br), coercivity (Hcj), and squareness (Hk/Hcj) of the NdFeB rare earth magnets obtained in Comparative Examples 1-5, measured at room temperature (20° C.) using a NIM-2000 magnetic property tester, are detailed in Table 2.

TABLE 1
Data of Remanence (Br), Coercivity (Hcj), and Squareness (Hk/Hcj)

| | | | | | | First | Second | Second | Magnet property | | |
|---|---|---|---|---|---|---|---|---|---|---|---|
| | Sintering | | Sintering | | First aging | aging | aging | aging | Br | Hcj | Hk/ |
| Category | temperature | | time | | temperature | time | temperature | time | kGs | kOe | Hcj |
| Example1 | 1070° | C. | 6 | h | 880° C. | 3 h | 430° C. | 7 h | 14.4 | 19 | 0.98 |
| Example2 | 1100° | C. | 4 | h | 850° C. | 3 h | 450° C. | 3 h | 13.5 | 24.5 | 0.98 |
| Example 3 | 1050° | C. | 6 | h | 750° C. | 5 h | 480° C. | 4 h | 14 | 22 | 0.98 |
| Example 4 | 1060° | C. | 8 | h | 700° C. | 7 h | 500° C. | 3 h | 13.2 | 23.5 | 0.98 |
| Example 5 | 950° | C. | 15 | h | 900° C. | 4 h | 550° C. | 3 h | 12.3 | 26 | 0.97 |

TABLE 2
Data of Remanence (Br), Coercivity (Hcj), and Squareness (Hk/Hcj)

| | | | | | | First | Second | Second | Magnet property | | |
|---|---|---|---|---|---|---|---|---|---|---|---|
| | Sintering | | Sintering | | First aging | aging | aging | aging | Br | Hcj | Hk/ |
| Category | temperature | | time | | temperature | time | temperature | time | kGs | kOe | Hcj |
| Comparative | 1070° | C. | 6 | h | 880° C. | 3 h | 410° C. | 7 h | 14.4 | 17 | 0.98 |
| Example 1 | | | | | | | | | | | |
| Comparative | 1100° | C. | 4 | h | 850° C. | 3 h | 420° C. | 3 h | 13.5 | 22.5 | 0.98 |
| Example 2 | | | | | | | | | | | |
| Comparative | 1050° | C. | 6 | h | 750° C. | 5 h | 410° C. | 4 h | 14 | 19 | 0.98 |
| Example 3 | | | | | | | | | | | |
| Comparative | 1060° | C. | 8 | h | 700° C. | 7 h | 560° C. | 3 h | 13.2 | 20.5 | 0.97 |
| Example 4 | | | | | | | | | | | |
| Comparative | 950° | C. | 15 | h | 900° C. | 4 h | 570° C. | 3 h | 12.3 | 22 | 0.97 |
| Example 5 | | | | | | | | | | | |

By comparing Table 1 and Table 2, it is found that the aging temperature has a significant impact on the diffusion performance, specifically as follows:
Process parameters of Example 1: Sintering temperature of 1070° C., sintering time of 6 hours, first aging temperature of 880° C., first aging time of 3 hours, second aging temperature of 430° C., second aging time of 7 hours. The magnet properties are Br=14.4 kGs, Hcj=19 kOe, and Hk/Hcj=0.98. It can be seen from Comparative Example 1 that the difference between them is that under the condition that the remanence (Br) and squareness (Hk/Hcj) remain basically unchanged, there is a significant difference in coercivity (Hcj), with a difference of 2 kOe. This indicates that the aging temperature has a great influence on the coercivity performance of the magnet.
Process parameters of Example 2: Sintering temperature of 1100° C., sintering time of 4 hours, first aging temperature of 850° C., first aging time of 3 hours, second aging temperature of 450° C., second aging time of 3 hours. The magnet properties are Br=13.5 kGs, Hcj=24.5 kOe, and Hk/Hcj=0.98. It can be seen from Comparative Example 2 that the difference between them is that under the condition that the remanence (Br) and squareness (Hk/Hcj) remain basically unchanged, there is a significant difference in coercivity (Hcj), with a difference of 2 kOe. This shows that the aging temperature has a significant impact on the coercivity performance of the magnet.
Process parameters of Example 3: Sintering temperature of 1050° C., sintering time of 5 hours, first aging temperature of 750° C., first aging time of 5 hours, second aging temperature of 480° C., second aging time of 4 hours. The magnet properties are Br=14.0 kGs, Hcj=22 kOe, and Hk/Hcj=0.98. It can be seen from Comparative Example 3 that the difference between them is that under the condition that the remanence (Br) and squareness (Hk/Hcj) remain basically unchanged, there is a significant difference in coercivity (Hcj), with a difference of 3 kOe. This demonstrates that the aging temperature has a substantial influence on the coercivity performance of the magnet.
Process parameters of Example 4: Sintering temperature of 1060° C., sintering time of 8 hours, first aging temperature of 700° C., first aging time of 7 hours, second aging temperature of 500° C., second aging time of 3 hours. The magnet properties are Br=13.2 kGs, Hcj=23.5 kOe, and Hk/Hcj=0.98. It can be seen from Comparative Example 4 that the difference between them is that under the condition that the remanence (Br) and squareness (Hk/Hcj) remain basically unchanged, there is a significant difference in coercivity (Hcj), with a difference of 3 kOe. This indicates that the aging temperature exerts a great influence on the coercivity performance of the magnet.
Process parameters of Example 5: Sintering temperature of 950° C., sintering time of 15 hours, first aging temperature of 900° C., first aging time of 4 hours, second aging temperature of 550° C., second aging time of 3 hours. The magnet properties are Br=12.3 kGs, Hcj=26 kOe, and Hk/Hcj=0.98. It can be seen from Comparative Example 5 that the difference between them is that under the condition that the remanence (Br) and squareness (Hk/Hcj) remain basically unchanged, there is a significant difference in coercivity (Hcj), with a difference of 4 kOe. This shows that the aging temperature has a very significant impact on the coercivity performance of the magnet.

TABLE 3
Atomic percentages of each element in the NdFeB rare earth magnet

| | two-particle grain boundary phase | | | triangular grain boundary phase | | | | |
|---|---|---|---|---|---|---|---|---|
| | | within | acicular | | | R-phase- | | |
| | within | 50 nm of | ZrBₓ | | | rich and | | acicular |
| | 20 nm of | the grain | phases or | | | FCC-type | | ZrBₓ |
| | the main | boundary | TiBₓ | RCu | RGa | NdOx | 6:14 | phases or |
| Category | phase | center | phase | phase | phase | phase | hase | TiBₓ phase |
| Example1 | Cu/R = | Cu/R = | ZrBx | Cu/R = | Ga/R = | This | This | ZrBx |
| | 1.6(AVG.) | 1.1(AVG.) | phase, | 1.05(AVG.) | 0.15(AVG.) | phase is | phase is | phase, |
| | | | width = | | | present | present | width = |
| | | | 15 nm(AVG.) | | | | | 15 nm(AVG.) |
| Example2 | Cu/R = | Cu/R = | ZrBx | Cu/R = | Ga/R = | This | This | ZrBx |
| | 2(AVG.) | 1.5(AVG.) | phase, | 1.5(AVG.) | 0.2(AVG.) | phase is | phase is | phase, |
| | | | width = | | | present | present | width = |
| | | | 50 nm(AVG.) | | | | | 50 nm(AVG.) |
| Example 3 | Cu/R = | Cu/R = | ZrBx | Cu/R = | Ga/R = | This | This | ZrBx |
| | 1.7(AVG.) | 1.2(AVG.) | phase, | 1.1(AVG.) | 0.5(AVG.) | phase is | phase is | phase, |
| | | | width = | | | present | present | width = |
| | | | 20 nm(AVG.) | | | | | 20 nm(AVG.) |
| Example 4 | Cu/R = | Cu/R = | TiBx | Cu/R = | Ga/R = | This | This | TiBx |
| | 1.8(AVG.) | 1.2(AVG.) | phase, | 1.3(AVG.) | 0.15(AVG.) | phase is | phase is | phase, |
| | | | width = | | | present | present | width = |
| | | | 15 nm(AVG.) | | | | | 15 nm(AVG.) |
| Example 5 | Cu/R = | Cu/R = | TiBx | Cu/R = | Ga/R = | This | This | TiBx |
| | 1.6(AVG.) | 1.2(AVG.) | phase, | 1.1(AVG.) | 0.15(AVG.) | phase is | phase is | phase, |
| | | | width = | | | present | present | width = |
| | | | 10 nm(AVG.) | | | | | 10 nm(AVG.) |

As can be seen from Table 3 above, the NdFeb rare earth magnets in Examples 1-5 are mainly composed of a main phase, a two-particle grain boundary phase, and a triangular grain boundary phase. The main phases are basically the same except for slight differences caused by different proportions of PrNd or pure Nd in R. As shown in FIGS. 2-7, the positions and scope definitions of the two-particle grain boundary phase and the triangular grain boundary phase are clarified, and the descriptions of the main phase, two-particle grain boundary phase, and triangular grain boundary phase are as follows:

The average Cu/R values within 20 nm of the main phase in the two-particle grain boundary phases of Examples 1-5 are 1.6, 2, 1.7, 1.8, and 1.6 respectively. The average Cu/R values within 50 nm of the grain boundary center in the two-particle grain boundary phases are 1.1, 1.5, 1.2, 1.2, and 1.2 respectively. Acicular high-melting-point phases exist in the two-particle grain boundary phases of Examples 1-5, with widths of 15, 50, 20, 15, and 10 nm respectively.

The triangular grain boundary phases (attached to the two-particle grain boundary phases) of Examples 1-5 all contain R-rich phases, FCC-type Nd-rich phases, and 6:14 phases. The average Cu/R values in the RCu phases are 1.05, 1.5, 1.1, 1.3, and 1.1 respectively, which meet the required standards. The average Ga/R values in the RGa phases are 0.15, 0.2, 0.5, 0.15, and 0.15 respectively, which also meet the required standards. Acicular high-melting-point phases exist in the triangular grain boundary phases of Examples 1-5, with widths of 15, 50, 20, 15, and 10 nm respectively. In summary, the NdFeB rare earth magnets obtained by this method do not contain heavy rare earths, and have good uniformity and high squareness. Both the coercivity and remanence of the NdFeB rare earth magnets can be adjusted through the design of grain boundary phases. The grain boundary phases contain thick non-magnetic phases, which play an excellent role in magnetic isolation and enhance the coercivity of the magnets. Additionally, the grain boundary phases contain uniform acicular ZrBₓ phases or TiBₓ phases, which provide excellent high-temperature resistance.

The above descriptions are only preferred embodiments of the present invention and are not intended to limit the present invention. Any modification, equivalent replacement, improvement, etc. made within the spirit and principle of the present invention shall be included in the protection scope of the present invention.

1. A NdFeB rare earth magnet, wherein:
the NdFeB rare earth magnet is a sintered NdFeB permanent magnet, comprising a main phase, a two-particle grain boundary phase, and a triangular grain boundary phase;
the main phase contains an R₂T₁₄B phase (in atomic percentage), where R refers to at least one of Nd (neodymium) and Pr (praseodymium), and T refers to at least Fe (iron) among Fe and Co (cobalt);
the two-particle grain boundary phase comprises:
a copper-rich grain boundary phase: within 20 nm from the interface of the main phase, the content of the copper-rich grain boundary phase satisfies 1.5<Cu/R≤2; within 50 nm from the center of the grain boundary, the content of the copper-rich grain boundary phase satisfies 1<Cu/R≤1.5;
and/or acicular ZrBₓ phase with a width of 10-50 nm;
and/or acicular TiBₓ phase with a width of 10-50 nm; and
the triangular grain boundary phase comprises: FCC-type NdOₓ phase, RCu phase (where 1<Cu/R≤1.5), RGa phase (where 0.1<Ga/R≤0.5), R-rich phase, 6:14 phase, and/or acicular ZrBₓ phase with a width of 10-50 nm, and/or acicular TiBₓ phase with a width of 10-50 nm.

2. The NdFeB rare earth magnet according to claim 1, wherein, based on 100% by mass percentage, the NdFeB rare earth magnet comprises the following components: R: 29.5-33.5%; B: 0.85-1.05%; Al: 0.05-0.8%; Cu: 0.4-2.0%; Ga: 0.3-0.6%; Co: 0.5-2.0%; Zr or Ti: 0.15-0.5%; the remainder is Fe (iron) and unavoidable impurities.

3. The NdFeB rare earth magnet according to claim 1, wherein R further includes at least one of La (lanthanum), Ce (cerium), Sm (samarium), Y (yttrium), Gd (gadolinium), Dy (dysprosium), Tb (terbium), and Ho (holmium).

4. A method for preparing the NdFeB rare earth magnet according to claim 1, comprising the following steps:
S1: subjecting raw materials to hydrogen absorption and dehydrogenation treatments to obtain hydrogen-treated ribbons of the main-phase alloy and ribbons of the relevant phases respectively;
S2: mixing the ribbon of the main-phase alloy and the ribbons of the relevant phases obtained in Step S1 at a certain ratio, performing mechanical crushing to achieve solid solution between the amorphous alloy and the main alloy, crushing the mixed powder material into powder, and conducting magnetic field forming to obtain a green compact; and
S3: placing the green compact into a sintering furnace for sintering forming and heat preservation to obtain a sintered blank, and performing two-stage aging treatment to obtain the NdFeB rare earth magnet.

5. A method for preparing the NdFeB rare earth magnet according to claim 4, wherein, in Step S1, the hydrogen absorption temperature is 50-100° C., the dehydrogenation temperature is 500-650° C., and the dehydrogenation time is 3-7 hours.

6. A method for preparing the NdFeB rare earth magnet according to claim 4, wherein, in Step S2, the particle size after mechanical crushing is 10-25 μm, the D50 particle size of the powder obtained by crushing and pulverizing is 2-7 μm, and the density of the green compact is 4.0-4.5 g/cm³.

7. A method for preparing the NdFeB rare earth magnet according to claim 4, wherein, in Step S3, the sintering temperature is 950-1100° C. with a heat preservation time of 4-15 hours; the first-stage aging temperature is 700-900° C. with a heat preservation time of 3-7 hours; and the second-stage aging temperature is 430-550° C. with a heat preservation time of 3-7 hours.
